(19) United States
(12) Patent Application Publication
(10) Pub. No.: US 2026/0133362 A1
(43) Pub. Date: May 14, 2026

(54) COATING A FIBRE, PARTICULARLY AN OPTICAL FIBRE, WITH A BORON NITRIDE-BASED COATING

(71) Applicants: CENTRE NATIONAL DE LA RECHERCHE SCIENTIFIQUE, Paris (FR); COMMISSARIAT A L'ENERGIE ATOMIQUE ET AUX ENERGIES ALTERNATIVES, Paris (FR); UNIVERSITE DE LILLE, Lille (FR)

(72) Inventors: Rémy BERNARD, La Madeleine (FR); Aymeric PASTRE, Lesquin (FR); Laure LAGO RACHED, Gif-sur-Yvette Cedex (FR); Guillaume LAFFONT, Gif-sur-Yvette Cedex (FR); Alexandre LERNER, Gif-sur-Yvette Cedex (FR)

(73) Assignees: CENTRE NATIONAL DE LA RECHERCHE SCIENTIFIQUE, Paris (FR); COMMISSARIAT A L'ENERGIE ATOMIQUE ET AUX ENERGIES ALTERNATIVES, Paris (FR); UNIVERSITE DE LILLE, Lille (FR)

(21) Appl. No.: 18/992,822

(22) PCT Filed: Jul. 10, 2023
(86) PCT No.: PCT/EP2023/068996

§ 371 Date: Jan. 9, 2025

(30) Foreign Application Priority Data
Jul. 12, 2022 (FR) FR2207160
May 25, 2023 (FR) FR2305200

(51) Int. Cl. G02B 6/02; C03C 25/14; C03C 25/16; C03C 25/42

(52) U.S. Cl. CPC G02B 6/02395; C03C 25/14; C03C 25/16; C03C 25/42

(57) ABSTRACT

The present invention relates to the use of optical fibres comprising a boron nitride (BN)-based coating, in a method for the additive manufacturing of ceramic structures. The present invention also relates to ceramic structures obtained by additive manufacturing comprising an optical component comprising one or more optical fibres as defined above.

### TECHNICAL FIELD

The present invention relates to the use of optical fibres comprising a boron nitride (BN)-based coating, in a method for the additive manufacturing of ceramic structures. The present invention also relates to ceramic structures obtained by additive manufacturing comprising an optical component comprising one or more optical fibres as defined above.

### PRIOR ART

The Additive Manufacturing (AM) methods allow the layer-by-layer production of ceramic parts with complex geometries, such as parts comprising recesses, or parts made of a lattice structure, or parts having geometric singularities that are difficult to obtain thanks to a subtractive manufacturing method.

There are different types of Additive Manufacturing methods. Examples include material extrusion, plasma spraying, thermal spraying, direct material deposition, selective powder-bed fusion, selective powder bed sintering, binder jetting, photopolymerisation.

The choice of AM method is generally dictated by the material of interest, the geometric constraints of the model to be manufactured, the final characteristics of the part (mechanical, thermal, aesthetic). The structures made of ceramic material by AM can be exposed to extreme environmental conditions. Instrumenting these parts at the core allows proposing an in situ monitoring of the AM method and subsequently monitoring the material health or the different thermomechanical loads to which they may be subjected during their life cycle.

These ceramic structures produced by AM can be used, for example, in the aeronautical industries in order to perform measurements in environments operating at high temperatures such as engines, or aerospace (turbine/stator blades, cryogenic environments such as liquid phase gas storage tanks), in the energy sector (gas turbines), or even in the nuclear industry (measurements in high temperature environments and/or under radiation). These methods can be applied to the manufacture of porous structures, architectural turbines, rotors, casting mould, connecting elements such as gears [1].

Fibre optic sensors (FOSs) allow measuring physical parameters such as temperature and/or deformation or even pressure in a distributed manner. They are not very intrusive (diameter in the range of a hundred microns), are insensitive to electromagnetic disturbances and allow these measurements to be carried out over wide temperature ranges, typically up to T≥800° C.

Thus, unlike sensors such as thermocouples for example, FOSs allow multipoint and multiparametric measurement of the surrounding environment.

The integration of FOSs within AM methods is typically achieved by an occasional interruption of printing, an appropriate positioning of the sensor, then the completion of the construction of the part.

The ceramic parts produced by AM, in particular in material extrusion methods, directed energy deposition, laminated object manufacturing, material spraying including material extrusion, directed energy deposition, laminated object manufacturing, material spraying including thermal spraying and plasma spraying, selective powder bed fusion or sintering, photopolymerisation can be subjected to very high temperatures (T≥800° C.). The integrated CFO must thus form a mechanically favourable interface with the surrounding matrix in order to accurately measure the physical parameters of interest (good thermal contact to minimise response time, good adhesion to optimise the transduction of the mechanical deformations and avoid the problems of slippage of the fibre relative to the host structure). A coating deposited on the glass sheath of the optical fibre allows protecting it during the sensor integration phase (handling by an operator or during the implementation of the method), but also forming this interface.

However, the materials currently available for these coatings do not withstand such high temperatures over long periods of use (typically 350° C. for polymer coatings and at most 700° C. for metal coatings).

Furthermore, these materials have a roughness that is far too low to reliably form a sufficient mechanical adhesion to the printed part, jeopardising the transfer of mechanical forces or vibrations, or even the temperature response time (interstitial air pockets). This results in CFOs that do not have the qualities required for their use.

These materials also have a coefficient of thermal expansion which is very different from that of the printed ceramic matrix. This results in constraints related to the differential expansion of the two materials which can occur when the room is heated. These constraints can lead to decohesion of the fibre/matrix interface, degradation of the coating or even rupture of the optical fibre.

There is therefore a need to propose an optical fibre whose coating makes it sufficiently resistant to withstand the extreme conditions of AM methods, in particular for methods allowing the integration: material extrusion, directed energy deposition, manufacturing of laminated objects, material spraying including thermal spraying and plasma spraying ion, selective powder bed fusion or sintering or even photopolymerisation.

The existing solutions are based on the use of polyimide [2] or metal [3,4] coatings. However, these materials have the drawback of being degraded at too low temperatures (about 350° C.) relative to those to which the parts made of ceramic AM can be exposed. They are therefore not suitable for a use in an AM [5] method.

Wnuk et al. [2] present the integration of FOSs with Bragg Gratings (BGRs), inscribed in an optical fibre sheathed by polyimide, in sprayed alumina (Al₂O₃). Although the temperature resistance of the integrated sensor has not been investigated, the long-term resistance of this coating material is only guaranteed for temperatures ≤350° C., which is not sufficient.

Duo et al. [4] integrated optical fibres coated with aluminium by thermal spraying with alumina flame (thermal spraying) on an aluminium substrate. Although no temperature tests were conducted on the instrumented samples, the optical transmission of the fibre is monitored during the deposition method. The potential exposure of the sample to high temperatures is limited, on the one hand, by the choice of the material on which the optical fibre is fixed (aluminium: melting at ˜660° C.), and on the other hand by the choice of the fibre coating (also made of aluminium: use at T ≤400° C.), which is not sufficient.

Lei et al. [6] integrated an intrinsic Fabry-Perot (IFP) inscribed with a femtosecond laser within a silica glass fibre. The uncoated CFO (i.e. Ø125 μm of silica) is placed in a groove machined in an alumina substrate, then embedded in an alumina-filled paste. The whole is then locally heated using a CO₂ laser allowing the consolidation of the filler material, i.e. the alumina-filled paste. Measurements are performed up to 800° C. on the instrumented sample. The optical fibre has not undergone any heat treatment prior to its integration, and the uncoated silica part output is supposedly very fragile after exposure to 800° C., making the handling of the sample very delicate and is therefore not satisfactory. In addition, the method which is described, and allowing the insertion of the optical fibre into the ceramic matrix, is very complex to implement.

The work of Petrie et al. [7,8] focuses on the integration of silica optical fibres within silicon carbide (SIC). A part is first built by binder spraying, a method during which layers of SiC particles are bound by a specific material, resulting in a mechanically very fragile part. It is then dried (at approximately 190° C.) and then densified thanks to the Chemical Vapour Infiltration (CVI) method. A chemical reaction under neutral gas and at approximately 1000° C. leads to the formation of crystalline SiC as well as the discharge of binders, resulting from AM by binder spraying. These steps are very complex to implement. In addition, the described method (CVI step) does not allow a priori producing large parts, requires a very long manufacturing time (crystallisation reaction of at least 5 hours), has a very high associated cost, and has the additional drawback of implementing reagents having a high toxicity. First, the authors present material compatibility tests between optical fibre coatings and SiC obtained by CVI, on sections of silica optical fibre: uncoated, coated with gold, and silver. They show that after exposure to about 1000° C. during the CVI method, a partial melting of the metal coatings is visible (FIG. 6 of Ref. [7]). This observation corroborates the limit of use of metal coatings at temperatures T≤700° C. as indicated by the different suppliers. The option of the “bare” optical fibre is described as the most suitable for their need (better interface with SiC), however the authors clearly mention the difficulties of handling a bare silica optical fibre after exposure to such temperatures (extreme fragility in the absence of a protective coating). In a second step, during the integration by CVI of silica optical fibres coated with different materials—acrylate (polymer) and ormocer (organically modified ceramic)—placed in Mo capillaries, the coatings have, as expected, completely burned. Unexpected distortions of the Mo capillaries at high temperature have led to their rupture. This breakage is described as accidental by the authors, and solely due to a defect in the fixing of the capillaries, not sufficiently accommodating the thermal expansions to which the structures were exposed during the CVI.

In the case of this work, the use of metal coatings proved to be irrelevant with regard to the temperatures imposed by the CVI, and the option of using a “bare” optical fibre is not a sustainable solution given its extreme fragility after exposure to high temperatures.

Thus, to the knowledge of the applicants, there is no optical fibre that has the properties required to be implemented in an AM method.

Some steps related to the integration method are limited in temperature due to the thermal resistance of the coatings used (about 350° C. for polyimide and about 400° C. for aluminium):
Stabilisation of residual stresses within the optical fibre resulting from the fibre-forming method,
Annealing of the part or stabilisation treatment of the ceramic matrix.

Then, these limits affect the range of use of the instrumented parts. It is also shown that the use of a “bare” optical fibre allows, in certain cases, reaching these high operating temperatures (T≥800° C.), but that this option is not viable for the purpose of instrumenting parts in difficult environments, where the systems are intended to be handled, which can induce bends and/or scratches in the optical fibres. These stresses, applied to an uncoated silica optical fibre, inevitably lead to their breakage.

There is therefore a need for the implementation of an AM method, of an optical fibre whose resistance allows maintaining its integrity up to its point of entry into the instrumented part, and also guaranteeing a healthy ceramic matrix/CFO interface up to at least 1000° C.

However, none of the mentioned documents teaches a fibre having the properties required for such use.

The present invention thus proposes the use of an optical fibre including an outer coating comprising a mixture of hexagonal boron nitride and bentonite, at a rate of at least 10% by weight of bentonite relative to the total weight of said outer coating, in a method for the additive manufacturing of ceramic structures. The use according to the invention allows developing and manufacturing optical fibre sensors coated with a ceramic material of controllable thickness with a view to their integration within ceramic structures produced by additive manufacturing, forming a mechanically reliable interface with the matrix up to very high temperature levels, for example 800° C. or higher. The invention also relates to ceramic structures including an optical component comprising one or more optical fibres as defined above.

### Description of the Invention

In order to solve the problems mentioned above, the applicant has developed the use of a fibre in a method for the additive manufacturing of ceramic structures, said fibre comprising a core made of a fibrable material and having an outer surface, said fibre being characterised in that it further includes an external coating including a mixture of hexagonal boron nitride and bentonite, at a rate of at least 10% by weight of bentonite relative to the total weight of said external coating.

Below 10% by weight of bentonite relative to the total weight of said external coating, the coating does not adhere to the fibre, whereas above 35% by weight of bentonite relative to the total weight of said external coating, the fibre thus coated is no longer flexible enough.

By fibrable material, it should be understood a material enabling fibre-forming, i.e. which can undergo a transformation of a bulk fibrable material. It may consist of a vitreous material having a glass transition enabling stretching thereof. Preferably, the core may be made of a material selected from among glass-transition materials and sapphire glass.

Advantageously, the external coating may be directly in contact with the core.

Advantageously, regardless of the considered embodiment, the core 11 of the fibre of the use according to the present invention may have a diameter comprised in an interval ranging between 20 μm to 10 mm, preferably between 80 μm to 500 μm and more preferably 125 μm.

Advantageously, the external coating may have a thickness comprised between 5 μm and 240 μm. If the core is cylindrical in shape, the thickness of the external coating will then be a radial thickness comprised between 5 μm and 240 μm.

Advantageously, the optical fibre including an external coating comprising a mixture of hexagonal boron nitride and bentonite, at a rate of at least 10% by weight of bentonite relative to the total weight of said external coating, can be selected from a standard optical fibre, a multicore fibre, a microstructured fibre, a tapered fibre, an optical coupler comprising one or more input fibres and one or more output fibres, a laser fibre, without this list being limiting.

Advantageously, the additive manufacturing method implemented according to the invention may comprise the steps of:
a) manufacturing a ceramic matrix from a ceramic material,
b) bringing at least one fibre 1 into contact with the ceramic matrix obtained in step a);
c) fastening the at least one fibre 1 to the surface of the ceramic matrix, possibly using elements on the periphery of the manufacturing area, so as to limit any relative movement of said fibre 1 relative to the ceramic matrix.
d) manufacturing a complementary matrix which is totally or partially covering the at least one fibre 1. The assembly formed by the ceramic matrices and the fibre forms a ceramic structure according to the invention.

Advantageously, the ceramic matrix is composed of an inorganic material, generally composed of metal, metalloid or non-metal atoms. These may be oxides (for example: aluminium oxide, zirconium oxide, doped or not), non-oxides (carbides, borides, nitrides), ceramics composed of silicon and atoms such as tungsten, magnesium, platinum or even titanium, and composite ceramics (combination of oxides and non-oxides). The choice of the material used to form the matrix is generally dictated by the geometric constraints of the model to be manufactured, the final characteristics of the ceramic structure that is manufactured (mechanical, thermal and aesthetic constraints).

The term “elements on the periphery of the manufacturing area” means mechanical or measuring systems located outside the volume inside which the matrix is manufactured by the method, and assisting in carrying out said method; it being understood that the manufacturing area is the volume inside which the matrix is manufactured using the manufacturing method.

the term “limitation of any relative movement of the fibre” means a technique allowing maintaining the fibre in a fixed position, for example using mechanical fastening systems or even adhesive materials. The amplitude of variation in the acceptable local position of the fibre around this said fixed position of the space as well as its frequency depend on the experimental conditions of the investigated method.

Advantageously, the additive manufacturing method can be selected from material extrusion, directed energy deposition, manufacturing of laminated objects, material spraying including thermal spraying and plasma spraying, selective powder bed fusion or sintering, photopolymerisation.

Advantageously, the method for manufacturing a ceramic structure is a method for manufacturing a ceramic structure instrumented with a CFO by atmospheric plasma spraying, and comprises the steps of:
a′) manufacturing a ceramic matrix from a ceramic material by atmospheric plasma spraying,
b′) bringing at least one fibre 1 into contact with the ceramic matrix obtained in step
a′) and obtaining an instrumented matrix;
c′) positioning the instrumented matrix obtained in step a) in a layer-by-layer deposition chamber of a ceramic material, by atmospheric plasma spraying on the instrumented matrix and integrating the at least one fibre 1, by completely or partially covering the at least one fibre 1 with said ceramic material; and obtaining a ceramic structure instrumented with a CFO.

The term “ceramic matrix” means a three-dimensional object or a volume of material manufactured using an additive manufacturing method. The term “instrumented matrix” means the material manufactured using the additive manufacturing method and capable of undergoing different post-treatments, and a volume of said material of a defined geometry comprising a CFO or a fibre on the surface thereof or within it.

The term “ceramic material” means an inorganic material composed of metal, metalloid or non-metal atoms. These may be oxides (for example: aluminium oxide, zirconium oxide, doped or not), non-oxides (carbides, borides, nitrides), ceramics composed of silicon and atoms such as tungsten, magnesium, platinum or even titanium, and composite ceramics (combination of oxides and non-oxides). These may be, for example, alumina (Al₂O₃), zirconia (ZrO₂), silicon carbide (SiC), tungsten carbide (WC), boron carbide (B4C), silicon nitride (S₃N₄), aluminium nitride (AlN), zirconium diboride (ZrB₂).

The term “deposition chamber” means a volume inside which the deposition is carried out using the additive manufacturing method. This volume is physically delimited by a wall that is sealed or not to the ambient atmosphere. Said deposition chamber has a volume depending on the additive manufacturing method, generally comprised between 0.001 m³ and 200m³.

Advantageously, in the case where the deposition chamber is sealed to the external atmosphere, the gas composition and the pressure of the atmosphere contained inside the deposition chamber can be controlled.

The term “layer-by-layer deposition” means the manufacture of a volume of material of predefined geometry by incremental or successive deposition of intermediate volumes of material circumscribed in said volume of predefined geometry.

In a first variant, the method for manufacturing a ceramic structure according to the invention comprises the steps of:
i) manufacturing a ceramic matrix from a ceramic material in an enclosure via a layer-by-layer deposition of the ceramic material,
ii) bringing at least one fibre 1 into contact with the ceramic matrix produced in step i) and obtaining an instrumented matrix;
iii) positioning the instrumented matrix obtained in step ii) in a deposition chamber and depositing, layer by layer, the ceramic material on the instrumented matrix in order to integrate the at least one fibre 1, by totally or partially covering at least one fibre 1 of said ceramic material; and obtaining a structure instrumented with a CFO,
iv) bringing at least one other fibre 1 into contact with the matrix manufactured during step iii) as described in step ii) and depositing a new matrix thickness to integrate these fibres as described in step iii), the number of iterations of step iii) being greater than or equal to 1, preferably from 1 to 5 iterations,
v) optionally physicochemical post-treatment of the part obtained following the preceding steps, by immersing it or not in an organic solvent, by exposing it or not to a temperature greater than 200° C.,
vi) optionally heat treatment of the part obtained in step v), said treatment consisting of exposing the part to a temperature greater than 600° C.

In a second variant, the method for manufacturing a ceramic structure according to the invention comprises the steps of:
i′) manufacturing a ceramic matrix from a ceramic material in a deposition chamber, via a layer-by-layer deposition of the ceramic material,
ii′) bringing into contact at least one fibre 1 and the ceramic matrix produced in step i′), inside the deposition chamber;
iii′) layer-by-layer depositing a ceramic material on the instrumented matrix by completely or partially covering the at least one fibre 1 of said ceramic material, in order to integrate the fibres 1, and obtaining a structure instrumented with a CFO, the number of iterations of step iii′) being greater than or equal to 1, preferably from 1 to 5 iterations,
iv′) optionally physicochemical post-treatment of the part obtained following the preceding steps, by immersion in an organic solvent, and/or exposure to a temperature greater than 200° C.
v′) optionally heat treatment of the pretreated part obtained in step iv′), said treatment consisting in exposing the part to a temperature greater than 600° C.

The present invention also relates to a ceramic structure including an optical component comprising one or more optical fibres according to the invention. The ceramic structure according to the invention is preferably selected from a turbine/stator blade, a rotor, a casting mould, a connecting element such as gears, a porous structure such as a filter.

Advantageously, the ceramic structure according to the invention is obtained by an additive manufacturing method, in particular a method as described above.

Advantageously, the ceramic structure according to the invention is composed of at least one optical component comprising one or more optical fibres according to the invention and a ceramic matrix, said matrix being composed of an inorganic material such as oxides, non-oxides, or a combination of oxides and non-oxides.

Within the scope of the invention, the term “optical component” means a fibre optic sensor of the Bragg grating type, spectrally or temporally multiplexed Bragg grating strings, quasi-continuous Bragg gratings that can be interrogated in frequency reflectometry, regenerated Bragg gratings, type II or microbubble strings, Rayleigh probes with or without amplification by nanoparticles integrated into the vitreous matrix or by nano-gratings obtained by femtosecond insolation of the vitreous matrix, intrinsic or extrinsic Fabry-Pérot, etched or not using a femtosecond laser. These fibre optic sensors can be manufactured from supports such as: standard optical fibre, multicore fibre, microstructured fibre, tapered fibre, optical coupler with one or more input fibres and one or more output fibres, laser fibre, without this list being limiting. Said optical components are integrated within ceramic structures produced by additive manufacturing, forming a mechanically reliable interface with the matrix up to very high temperature levels and ensuring the protection of the optical fibre before its insertion within or in the sub-surface of the part.

The fibres and FOSs implemented according to the use or the method according to the invention further allow carrying out the in situ monitoring of the additive manufacturing method used for the integration. This in situ monitoring can be carried out by interrogating the CFO using an acquisition system adapted to the type of CFO integrated thanks to the additive manufacturing method. The measured quantities can be, for example, the temperature and/or the deformation.

The fibres and FOSs implemented according to the use or the method according to the invention can withstand the heat treatments potentially applied to the parts resulting from additive manufacturing intended to stabilise their thermomechanical properties (debinding, densification, annealing for example, within the limit of ˜1000° C. for silica optical fibres). This treatment is generally accompanied by a shrinking/compaction of the material, favourable to the mechanical strength of the integrated CFO because it is more resistant in compression than in tension.

The instrumented ceramic material part of the integrated CFO allows measurements to be taken, for example of temperature and/or deformation, in a difficult environment, and in particular at high temperature (T≥800° C.), with the aim of Structural Health Monitoring (SHM)

The fibre or CFO coated with the ceramic material maintains its reliability (metrological and mechanical) at high temperatures, as well as its compatibility with the material of the instrumented part. It also has low intrusiveness (typically 100-500 um in diameter) within the structures and allows the multipoint (multiplexing) and multiparametric measurements to be carried out. The coated CFO can also be integrated along a complex path within the instrumented part. It is also possible to integrate several FOSs within the same part, at different sites of interest.

Advantageously, the shape of the ceramic structures produced using the AM method can be more or less complex depending on the intended application. For example, these can be disks, parallelepipeds, shapes of revolution such as hollow or non-hollow cylinders, shapes of revolution with added elements such as fins, without this list being exhaustive.

The dimensions of the manufactured ceramic structures are comprised along one of the axes of space—between 0.1 mm and 1 m and preferably between 1 mm and 500 mm.

According to reference [9], the ceramic materials applicable by thermal spraying are materials with a high melting point such as ceramics (oxides and carbides). Technical ceramics are defined in three different categories: oxides (for example: aluminium oxide, zirconium oxide, doped or not), non-oxides (carbides, borides, nitrides, ceramics composed of silicon and atoms such as tungsten, magnesium, platinum or titanium), and composite ceramics (combination of oxides and non-oxides).

The at least one fibre 1 implemented in the present use according to the invention can be manufactured from a pasty composition for fibre. The method for manufacturing a pasty composition for fibre coating may comprise the following steps:
A) dispersing in water a dry mixture of hexagonal boron nitride BN and bentonite to ensure a proper mixing of bentonite and boron nitride, the dry mixture comprising at least 10% by weight of bentonite relative to the total weight of said dry mixture, to form an aqueous suspension;
B) evaporating the water contained in said aqueous suspension, until obtaining a pulverulent dry extract;
C) dispersing said pulverulent dry extract in water to form a pasty composition, in a proportion of at least 40% by weight of dry extract in water.

Advantageously, step B) of the method for manufacturing a pasty composition for fibre coating according to the invention can be carried out under primary vacuum or under atmospheric pressure, and at a temperature which can be comprised between 50° C. and 90° C., preferably between 60° C. and 80° C., and better still in the range of 60° C.

The pasty composition for optical fibre coating implemented in the present use according to the invention can be obtained by the manufacturing method mentioned above.

Advantageously, the pasty composition may further comprise a dopant, which may advantageously be based on carbon, zirconium oxides, titanium oxides and nanoparticles of metals or semiconductors, organic fillers (organic and organometallic molecular compounds), inorganic fillers and mixtures thereof.

The fibre implemented in the use according to the invention can be manufactured according to a manufacturing method using such a pasty composition to obtain the deposition of an external coating on the outer surface of a fibre, the method comprising the following steps:
A) providing or producing a fibre core made of fibrable material (without protective coating);
B) providing a pasty composition for fibre coating according to the invention;
C) coating at least one portion of said fibre with said pasty composition so as to form a wet layer on said fibre;
D) heat treatment of said optical fibre coated with said wet layer at a temperature comprised between 100° C. and 250° C. for a sufficient time to form an external coating layer 2 capable of being handled (in this case rolled up and manipulated).

Advantageously, steps C and D can be repeated one or more times until the desired thickness of the external coating is obtained.

Advantageously, the method for manufacturing the fibre can also comprise a step A′ of stripping the fibre according to the invention, to remove, over at least one portion of the length of the fibre, the protective sheath present in the case of providing a commercial fibre. Preferably, this step A′ may be carried out by contacting the protective sheath with a dichloromethane solution, in the case of a protective sheath made of polyacrylate. Other methods of stripping the fibre are possible, for example by mechanical stripping with a clamp or a razor blade. Nonetheless, as regards optical fibres intended to be handled at least once, it is preferable to consider a chemical stripping.

Other advantages and particularities of the present invention will arise from the following description, given as a non-limiting example and made with reference to the appended figures and to the examples.

### BRIEF DESCRIPTION OF THE FIGURES

The following examples illustrate the invention, in connection with the figures discussed hereinabove, yet without limiting the scope thereof:

FIG. 1 shows a cross-sectional view (A) and a perspective view (B) of a first example of a fibre according to the invention (fibre without protective sheath); the fibre 1 comprises a core 11 made of fibrable material and has an outer surface 111, covered by an external coating 2 based on hexagonal boron nitride and bentonite.

FIG. 2 comprises two optical microscope photographs of the fibre 1 (post-method) covered by an external coating 2 based on hexagonal boron nitride and bentonite after a heat treatment at 1000° C., at different focusing distances (4A on the edges of the fibre and 4B on the surface of the fibre).

FIG. 3 represents the relative variation over time of the response of a Bragg grating (Δλ_{Bragg}) at 800°° C. for 800 hours, for a bare fibre (in solid line) and a fibre according to the invention, provided with a coating comprising three layers of boron nitride-based coating (in dotted lines).

FIG. 4 represents the relative variation over time of the response of a Bragg grating inscribed in an optical fibre coated with the boron nitride-based material during its integration using the atmospheric plasma spraying method.

FIG. 5 represents, on the one hand, the relative variation over time of the response of five Bragg gratings integrated within a parallelepiped sample subjected to repeated bending loads at four points. FIG. 5 also shows the evolution over time of the temperature in the test chamber as well as that of the mechanical load applied to the sample.

FIG. 6 represents a synoptic of the different steps allowing manufacturing a ceramic material structure produced by additive manufacturing, comprising at least one CFO protected by the boron nitride-based coating, according to the invention.

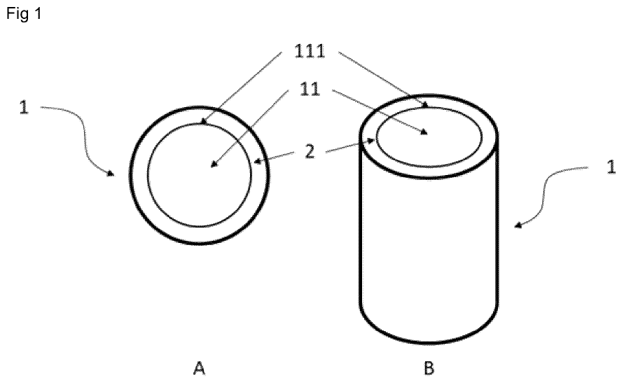

### EXAMPLES

The nature of the products used for manufacturing the fibres and the implemented method, as well as the characterisation methods are detailed below.

### Products, Raw Materials

solvent for chemical stripping: dichloromethane, isopropanol;
hexagonal BN powder;
bentonite of general formula Al₂H₂O₁₂Si₄;
samples of optical fibres (in particular silica, sapphire, or chalcogenide) comprising or not a protective sheath made of organic polymer (for example polyacrylate).

### Structural and Microstructural Characterisation Devices and Tests

A complete physicochemical characterisation has been carried out with complementary techniques at different scales to characterise the applied coating layer using:
optical microscopy,
X-ray diffraction (XRD) analysis,
high temperature resistance test comprising heating of the fibre samples according to the invention at 1,000° C., with a heating ramp at 10° C./min, followed by inertia or instantaneous cooling;
determination of the behaviour of the Bragg response of the fibre samples according to the invention by analysis of the reflectivity at the Bragg wavelength via a broadband laser source and an optical spectrum analyser.

### Example 1: Manufacture of an Example of Pasty Composition C for Fibre Coating

Boron nitride and bentonite (at least 10% by weight of bentonite) are ground using a planetary mill, with a reversal of the direction of rotation every 5 minutes (for a satisfactory particle size).

The ground product thus obtained is dispersed in a large amount of water (about 250 mL) to form a suspension.

The suspension thus obtained is evaporated to dryness in a 500 mL Schlenk tube. The evaporation is done under a primary vacuum (10⁻³ Pa) using a vacuum/argon manifold. Throughout the duration of the operation, the Schlenk tube is maintained at 60° C. in a water bath, via an oil bath. After 4 to 6 hours of evaporation: the dry obtained extract is manually ground (with mortar and pestle). The obtained powder may be stored in an oven at 50° C. or in a desiccator for several months.

At the time of performing the deposition over the fibre, the obtained powder is dispersed in at least 20 mL of distilled water.

The pasty composition according to the invention C is obtained.

### Example 2: Manufacture of a Fibre Coated with Boron Nitride-Based Material

### Step A

Samples of optical fibres without protective sheath are used. In the case of providing samples of commercial optical fibres (in particular silica, sapphire, or chalcogenide) comprising a protective sheath in polyacrylate, an additional stripping step is necessary during a step A′.

### Step A′

It should be recalled that, during manufacture thereof, the optical fibres are conventionally protected by organic polymers: without this protective coating, the optical fibres are extremely vulnerable to mechanical contacts, making them difficult to handle. Yet, this organic coating is by nature incompatible with a deployment of the optical fibre in a severe environment.

Hence, it is preferable to at least partially pull off this coating. Preferably, this stripping operation A′ is carried out by a chemical attack. The interest of this step A′ is to strip a specific portion of the optical fibre, either at one end or over an area defined beforehand. Generally, at each end of the fibre, the initial coating is kept over a sufficient length so as to be able to at least maintain the fibre in position during the coating deposition step without weakening it. The lengths are adjusted according to the targeted application type.

The used solvent is dichloromethane, in the case of a polyacrylate-type original protective sheath (standard case).

If the commercial optical fibre samples comprise a protective sheath made of a polymer other than a polyacrylate and which is not sensitive to dichloromethane, another solvent capable of dissolving this polymer will be used. For example, if the protective sheath is made of polyimide, hydrochloric acid or hot sulphuric acid will be used to dissolve it.

Step A′ of chemical stripping allows avoiding weakening the fibre, unlike a mechanical stripping (with a clamp or with a razor blade).

### Step B

The pasty composition C of Example 1 is used.

### Step C

Then, at least one portion of a stripped fibre sample is coated with the pasty composition C so as to form a wet layer on the fibre, for example by immersion or directly on a fibre-forming tower.

### Step D

The sample is then dried. It can be placed in an oven at 100° C. The coating is dry to the touch after 15 seconds. After this treatment, the fibre could be wound on a standard coil (typically with a 158 mm radius). It can also be dried in a vertical tubular oven directly on the fibre-forming tower, below the die holder. The hot area is about 250 mm. The oven temperature is 250° C.

### Example 3°: Characterisation of the Coatings

Afterwards, different tests have been carried out to characterise the BN and bentonite coatings in accordance with the invention.

In order to reveal any physicochemical modifications of the coating (prohibitive for the targeted applications), the samples are observed under an optical microscope, characterised in XRD, and under different temperature conditions. The optomechanical behaviour is also studied.

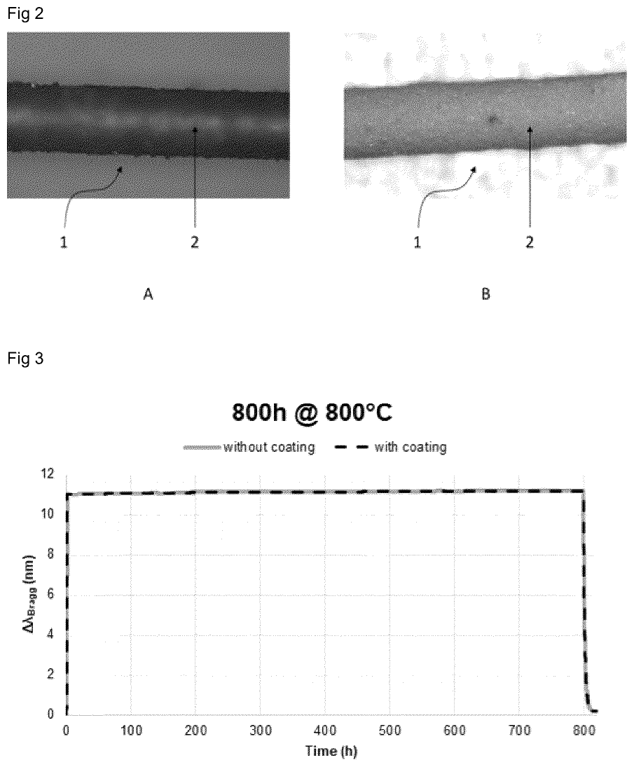

A first temperature resistance test of the coatings formed in Example 2 has been carried out at 1,000° C., raised at 10° C./min up to 1,000° C., for a duration of 500 hours, then cooling by inertia. FIG. 2 is an observation of the sample under an optical microscope after this heat treatment. These observations show that the coating features no alteration of its integrity (crack or fracture).

Other fibre samples with BN-coated Bragg gratings are also studied under different isotherms (at high and low temperatures), in order to validate the criterion of no modification of the fibre's optomechanical properties. Indeed, it is essential that the coating does not alter the sensitivity of the sensor it protects. Successive heating and cooling cycles are also repeated on samples with and without coating in order to validate the proper dynamic behaviour (thermal expansion of the different materials).

Similarly, the behaviour of the Bragg response is compared with and without coating, as illustrated in FIG. 3 during a cycle of more than 800 hours at 800° C.

### Example 4: Fibre Optic Sensor Integrated into a Mechanical Test Specimen by an Additive Manufacturing Method Implemented with the Fibre Obtained in Example 2

### Manufacture of CFOs

In this example, the CFOs are made up of wavelength-multiplexed Bragg Gratings (BGRs), with a physical length of 1 mm.

These BGRs are inscribed in the core of a silica optical fibre using laser pulses with a unit duration comprised, here, between 100 and 200 fs.

This inscription method allows obtaining BGRs resistant to high environmental temperatures (T° >°800° C.).

The BGRs are inscribed through the initial coating of the optical fibre (acrylate polymer), here transparent to wavelengths belonging to the visible light range. This allows the mechanical integrity of the fibres to be preserved during their transport to the coating application step.

The optical fibres inscribed with BGRs are stripped of their initial coating then coated with the boron nitride-based protective material as described in Example 2.

A stabilisation heat treatment is applied to the CFOs coated with the protective material.

This heat treatment comprises the step presented in Example 2, i.e. a first step at 100° C.

This heat treatment is completed by a step at 500° C. for 1 h and then at 750° C. for 2 h. These steps are used to stabilise the coating material but also the BGR inscribed in the core of the optical fibre.

### Integration of CFOs

The manufacturing method discussed in this example is the atmospheric plasma spraying of ceramic material.

A powder of ceramic material, here cordierite (Al₃Mg₂AlSi₅O₁₈) is introduced into a plasma torch. This plasma is generated by circulating gases between electrodes between which an electric voltage is applied, generating an electric arc.

The particles of ceramic material melt on contact with the plasma. They are transported by the latter at a speed depending on the method parameters known to those skilled in the art.

The scanning of the plasma torch relative to a manufacturing surface allows depositing layers, for example a few microns thick, on said surface.

In this example, a first step a) consists in depositing a millimetre thickness of material in order to form the CFO integration support, that is to say a ceramic matrix.

This support has a surface area of 15×45 ° mm².

A second step b) consists in positioning the CFO coated with the boron nitride-based protective material on the ceramic matrix. The CFO is held in position using point additions of adhesive during a third step c). It is essential to ensure a tension in the fibre so that it is pressed against the ceramic matrix and thus limit any relative movement of the fibre relative to said ceramic matrix.

A fourth step d) consists in depositing an additional thickness of cordierite which is sprayed onto the surface of the instrumented matrix during step c) to embed the CFO in the material.

### In Situ Monitoring of the Method

Continuous interrogation of the BGRs using a suitable instrument allows monitoring the progress of the manufacturing method, that is to say the successive deposition of each layer of material.

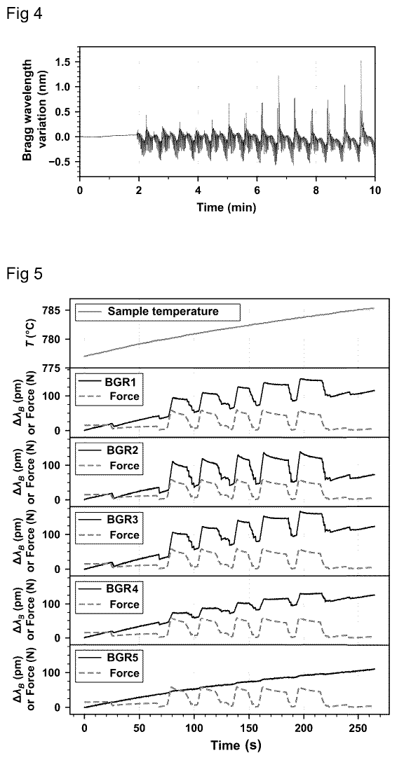

For example, FIG. 4 shows the Bragg wavelength shift measured by an BGR during the plasma spraying method. This response is sensitive to variations in deformation and temperature within the material.

The advantage of a method monitoring by CFO compared to the techniques commonly used, such as pyrometry for example, lies in the volume probed by the CFOs (a few μm³) which is much smaller than the so-called usual techniques.

### High Temperature Tests

The quality of the interface formed between the coated CFO and the material deposited by the plasma spraying method is studied by subjecting the instrumented sample to mechanical bending loads, by varying the test temperature.

The test temperatures are comprised between ambient temperature and 800° C., more specifically 27° C.°; 148° C.°; 344° C.°; 572° C.°; 782° C.

The mechanical loads are applied thanks to four-point bending supports positioned in the temperature servo-controlled enclosure.

Five mechanical loads of 60° N each are applied at each test temperature.

The response of the BGRs under the effect of the mechanical loading is shown in FIG. 5. This response differs according to the respective position of the BGRs along the length of the pad, because the four-point bending test induces a strain field dependent on the longitudinal position.

The absence of significant dropout in the response of the BGRs under the effect of the mechanical loading shows that the interface maintains its mechanical integrity up to the maximum test temperature.

Indeed, a dropout in the response of the BGRs under the effect of the mechanical loading would indicate a loss of strain transfer between the material deposited by plasma spraying and the CFOs coated with the boron nitride-based material.

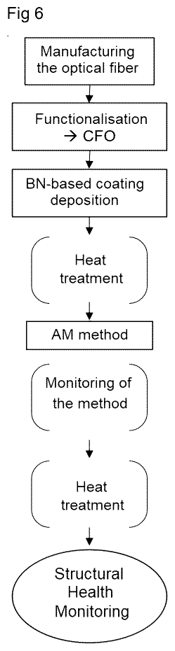

The different steps described in the context of this example are summarised in FIG. 6. In this figure, the steps in boxes are considered necessary to obtain a ceramic part produced by AM and instrumented with a CFO, and the steps in brackets are optional or can vary, for example, depending on the chosen method.

### LIST OF THE REFERENCES

1. Z. Chen, Z. Li, J. Li, C. Liu, C. Lao, Y. Fu, C. Liu, Y. Li, P. Wang, and Y. He, “3D printing of ceramics: A review,” Journal of the European Ceramic Society 39, 661-687 (2019).
2. V. P. Wnuk, A. Mendez, S. Ferguson, and T. Graver, “Process for mounting and packaging of fiber Bragg grating strain sensors for use in harsh environment applications,” in E. Udd and D. Inaudi, eds. 2005, p. 46.
3. D. Havermann, J. Mathew, W. N. MacPherson, R. R. J. Maier, and D. P. Hand, “Temperature and Strain Measurements With Fiber Bragg Gratings Embedded in Stainless Steel 316,” Journal of Lightwave Technology 33, 2474-2479 (2015).
4. Y. Duo, S. Costil, P. Pfeiffer, and B. Serio, “Embedding properties of optical fibers integrated into ceramic coatings obtained by wire flame thermal spray,” Smart Mater. Struct. 24, 035027 (2015).
5. L. Huang, R. S. Dyer, R. J. Lago, A. A. Stolov, and J. Li, “Mechanical properties of polyimide coated optical fibers at elevated temperatures,” in Optical Fibers and Sensors for Medical Diagnostics and Treatment Applications XVI (International Society for Optics and Photonics, 2016), Vol. 9702, p. 97020Y.
6. J. Lei, Q. Zhang, Y. Song, J. Tang, J. Tong, F. Peng, and H. Xiao, “Laser-assisted embedding of all-glass optical fiber sensors into bulk ceramics for high-temperature applications,” Optics & Laser Technology 128, 106223 (2020).
7. C. M. Petrie, A. M. Schrell, D. N. Leonard, Y. Yang, B. C. Jolly, and K. A. Terrani, “Embedded sensors in additively manufactured silicon carbide,” Journal of Nuclear Materials 153012 (2021 ).
8. C. M. Petrie, A. Schrell, D. Leonard, B. C. Jolly, and K. A. Terrani, Demonstration of Embedded Sensors in Ceramic Structures (Oak Ridge National Lab. (ORNL), Oak Ridge, TN (United States), 2020).
9. P. Fauchais, “Dépöts céramiques par PVD ou CVD assistées ou par projection plasma,” Techniques de l'ingénieur Frottement, usure et lubrification base documentaire: TIP574WEB., (2013).

1. A use of an optical fibre in a method for additive manufacturing of ceramic structures, the fibre comprising
a core made of a material allowing fibre-forming and having an outer surface, and
an external coating including a mixture of hexagonal boron nitride and bentonite, at a rate of at least 10% by weight of bentonite relative to a total weight of the external coating.

2. The use according to claim 1, according to which the core of the fibre is made of a material selected from glass transition materials and sapphire glass.

3. The use according to claim 1, wherein the external coating of the fibre is directly in contact with the core.

4. The use according to claim 1, wherein the core of said the fibre has a diameter comprised in an interval ranging between 20 μm to 10 mm.

5. The use according to claim 1, wherein the outer coating of the fibre has a thickness comprised between 5 μm and 240 μm.

6. A ceramic structure, selected from
turbine/stator blades,
a rotor,
a casting mould,
a connecting element, and
a porous structure,
including an optical component comprising one or more optical fibres as defined according to claim 1.

7. The use according to claim 1, wherein the additive manufacturing method comprises:
a) manufacturing a ceramic matrix from a ceramic material;
b) bringing at least one fibre as described in claim 1 into contact with the ceramic matrix obtained in a);
c) fastening the at least one fibre to the surface of the ceramic matrix so as to limit any relative movement of the fibre relative to the ceramic matrix; and
d) manufacturing a volume of complementary material which is totally or partially covering the fibre.

8. The use according to claim 1, wherein the additive manufacturing method is selected from a plasma spraying or thermal spraying method, material extrusion, directed energy deposition, manufacturing of laminated objects, selective powder-bed fusion, selective powder bed sintering, binder jetting, and photopolymerisation.

9. A method for manufacturing by atmospheric plasma spraying of a ceramic structure instrumented with a CFO, the ceramic structure selected from
turbine/stator blades,
a rotor,
a casting mould,
a connecting element, and
a porous structure,
including an optical component comprising one or more optical fibres as defined according to claim 1, comprising:
a′) manufacturing a ceramic matrix from a ceramic material by atmospheric plasma spraying,
b′) bringing at least one fibre as described in claim 1 into contact with the ceramic matrix obtained in a′) and obtaining an instrumented matrix;
c′) positioning the instrumented matrix obtained in b′) in a deposition chamber and deposition, layer by layer, of a second ceramic material, by atmospheric plasma spraying on the instrumented matrix and integration of the at least one fibre; and
obtaining the ceramic structure instrumented with a CFO.

10. A method for manufacturing a ceramic structure, selected from
turbine/stator blades.
a rotor,
a casting mould,
a connecting element, and
a porous structure,
including an optical component comprising one or more optical fibres as defined according to claim 1, comprising:
i) manufacturing a ceramic matrix from a ceramic material in an enclosure via a layer-by-layer deposition of the ceramic material,
ii) bringing at least one fibre as described in claim 1 into contact with the ceramic matrix produced in i) and obtaining an instrumented matrix;
iii) positioning the instrumented matrix obtained in ii) in a deposition chamber and depositing, layer by layer, the ceramic material on the instrumented matrix in order to integrate at least one fibre, by totally or partially covering at least one fibre of the ceramic material; and obtaining a structure instrumented with a CFO, and
iv) bringing at least one other fibre into contact with the matrix manufactured during iii) as described in ii) and depositing a new matrix thickness to integrate the at least one fibre as described in iii), a number of iterations of iii) being greater than or equal to 1.

11. A method for manufacturing a ceramic structure, selected from
turbine/stator blades,
a rotor,
a casting mould,
a connecting element, and
a porous structure,
including an optical component comprising one or more optical fibres as defined according to claim 1, comprising
i′) manufacturing a ceramic matrix from a ceramic material in a deposition chamber, via a layer-by-layer deposition of the ceramic material,
ii′) bringing into contact at least one fibre as described in claim 1 and the ceramic matrix produced in i′), inside the deposition chamber; and
iii′) layer-by-layer deposition of a ceramic material on the instrumented matrix by completely or partially covering the at least one fibre of the ceramic material, in order to integrate the at least one fibre and obtaining a structure instrumented with a CFO, a number of iterations of iii′) being greater than or equal to 1.

12. The method for manufacturing a ceramic structure according to claim 11, further comprising
iv′) physicochemically post-treating of the instrumented structure obtained in iii′) by immersion in an organic solvent, and/or exposure to a temperature greater than 200° C.; and
v′) heat treating the instrumented structure obtained in iv′), the heat treating comprising exposing the instrumented structure obtained in iv′) to a temperature greater than 600° C.

13. the method for manufacturing a ceramic structure according to claim 11, wherein the number of iterations is 1-5.

14. A method for manufacturing a ceramic structure according to claim 10, further comprising
v) physicochemically post-treating a structure obtained in iv), by immersing it in an organic solvent, and by exposing the structure obtained in iv) to temperatures greater than 200° C., and
vi) heat treating of the part obtained in v), the treating comprising exposing the part obtained in v) to a temperature greater than 600° C.

15. the method for manufacturing a ceramic structure according to claim 10, wherein the number of iterations is 1-5.

16. The use according to claim 4, wherein the diameter is comprised in an interval ranging between.
